(19) United States
(12) Patent Application Publication
(10) Pub. No.: US 2011/0285333 A1
(43) Pub. Date: Nov. 24, 2011

(54) MOTOR DRIVE UNIT

(76) Inventors: Yoshinao KOBAYASHI, Osaka (JP); Taishi Iwanaga, Shiga (JP)

(21) Appl. No.: 13/078,639

(22) Filed: Apr. 1, 2011

(30) Foreign Application Priority Data
May 19, 2010 (JP) 2010-115274

(51) Int. Cl. H02P 23/14

(52) U.S. Cl. 318/400.14

(57) ABSTRACT

A motor drive unit includes a position detection section configured to detect a rotor position by detecting a zero cross of a counter electromotive voltage during a de-energizing period to output a position detection signal, a current waveform generation section configured to generate, based on a torque command signal and the position detection signal, a current waveform which is to flow through the motor and includes the de-energizing period, an energizing control section configured to generate a control signal for controlling energizing of each of motor coils, and perform switching of an energizing phase of the motor based on the position detection signal, and a drive section configured to supply a current to each of the motor coils according to the control by the energizing control section, and the current waveform generation section changes a start timing of the de-energizing period according to a given control signal.

### CROSS-REFERENCE TO RELATED APPLICATION

This application claims priority to Japanese Patent Application No. 2010-115274 filed on May 19, 2010, the disclosure of which including the specification, the drawings, and the claims is hereby incorporated by reference in its entirety.

### BACKGROUND

The present disclosure relates to a motor drive unit, and more particularly relates to a drive unit which drives a sensorless motor which does not include a position detection device for detecting a rotor position.

As spindle motors for disc devices employing a magnetic disc, an optical disc, and a magneto-optical disc, etc., brushless motors which are highly reliable and capable of high-speed operation have been widely used. In general, a drive unit for a brushless motor controls a timing of switching of an energizing phase, based on rotor position information obtained from a position detection device such as a hall element, etc., incorporated in the motor.

A drive unit for a sensorless motor which does not include a position detection device detects a rotational position of a rotor by detecting a zero cross of a counter electromotive voltage which is generated as a potential difference between an energizing terminal and a neutral terminal of each coil when a rotor rotates, and controls a timing of switching of an energizing phase, based on rotor position information. In driving the sensorless motor, if a current flows through a motor coil having a corresponding phase to a counter electromotive voltage when detection of the counter electromotive voltage is performed, the counter electromotive voltage might not be properly detected, so that the motor might not be driven in a stable manner. Thus, a de-energizing period is provided so that the motor coil is not caused to be energized, and thus, a current flowing in a motor coil having a phase corresponding to that of the counter electromotive voltage to be detected is caused to be zero (see, e.g., Japanese Patent Publication No. H4-244797).

### SUMMARY

In general, when acceleration control or deceleration control is performed to a motor, a larger current flows through a motor coil, as compared to when constant rotation control is performed to the motor. Therefore, in driving a sensorless motor, it is necessary to ensure a sufficiently long de-energizing period so that false detection of a counter electromotive voltage does not occur when acceleration control or deceleration control is performed. However, when a de-energizing period is provided, a problem arises in which vibrations occur at a timing of switching of an energizing phase, and also, noise along with the vibrations occurs. Specifically, in driving a sensorless motor in a conventional manner, assuming the worst case, a de-energizing period is set. Therefore, when the motor is driven in a stable manner, for example, during constant rotation control, etc., an excessively long de-energizing period occurs, thus, resulting in the generation of vibrations and noise.

The present disclosure may be advantageous for reducing such vibrations and noise in a senseless motor driving.

An example drive unit which drives a sensorless motor, the drive unit includes: a position detection section configured to detect a rotor position of the motor by detecting a zero cross of a counter electromotive voltage generated on a motor coil during a de-energizing period to output a position detection signal; a current waveform generation section configured to generate, based on a torque command signal and the position detection signal, a current waveform which is to flow through the motor, and which includes the de-energizing period; an energizing control section configured to modulate the current waveform to generate a control signal for controlling energizing of each of the motor coils, and perform switching of an energizing phase of the motor based on the position detection signal; and a drive section configured to supply a current to each of the motor coils according to the control by the energizing control section, and the current waveform generation section changes a start timing of the de-energizing period according to the given control signal.

Specifically, the current waveform generation section includes a segment dividing section configured to divide one cycle of the position detection signal into a plurality of segments to output a segment signal indicating an associated one of the segments, a de-energizing period specification section configured to be reset by the position detection signal to output a de-energizing period signal which becomes a predetermined logic level during last ones of the plurality of segments corresponding to the control signal, and a waveform generation section configured to generate the current waveform, based on the torque command signal, the segment signal, and the de-energizing period signal.

The drive unit may includes at least one of a torque command detection section configured to detect an amount of change in the torque command signal to generate a control signal according to a result of the detection, a rotation speed detection section configured to detect an amount of change in a rotation speed of the motor to generate a control signal according to a result of the detection, and a detection timing detection section configured to detect a detection timing of a counter electromotive voltage to generate a control signal according to a result of the detection, and a logical operation section configured to perform a logical operation on the control signals output from these detection sections and an external signal to generate the control signal to be input to the current waveform generation section.

### BRIEF DESCRIPTION OF THE DRAWINGS

FIG. 1 is a block diagram of a motor drive unit according to a first embodiment.

FIG. 2 is a diagram illustrating an example configuration of an energizing period specification section.

FIG. 3 is a waveform chart showing waveforms of various signals in a current waveform generation section.

FIG. 4 is a block diagram of a motor drive unit according to a second embodiment.

FIG. 5 is a block diagram of a motor drive unit according to a third embodiment.

FIG. 6 is a block diagram of a motor drive unit according to a fourth embodiment.

FIG. 7 is a diagram illustrating an example configuration of a detection timing detection section.

FIG. 8 is a waveform chart showing waveforms of various signals in the detection timing detection section.

FIG. 9 is a diagram illustrating another example configuration of the detection timing detection section.

FIG. 10 is a block diagram of a motor drive unit according to a fifth embodiment.

### DETAILED DESCRIPTION

### First Embodiment

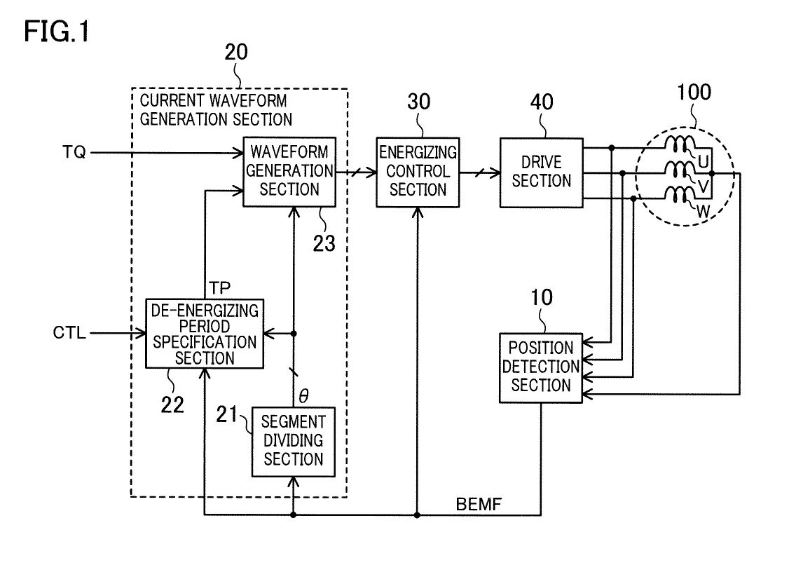

FIG. 1 illustrates a configuration of a motor drive unit according to a first embodiment. A motor 100, which the motor drive unit of this embodiment drives, is, for example, a three-phase sensorless motor. In the motor drive unit of this embodiment, a position detection section 10 detects a rotor position of the motor 100 by detecting a zero cross of a counter electromotive voltage generated at motor coils U, V, and W during a de-energizing period, and outputs a position detection signal BEMF. A current waveform generation section 20 generates a current waveform which is to flow through the motor 100, based on a torque command signal TQ and BEMF. The current waveform includes a de-energizing period. An energizing control section 30 performs a modulation such as PWM to the current waveform to generate a control signal for controlling energizing of each of the motor coils, and performs switching of an energizing phase of the motor 100 based on BEMF. A drive section 40 supplies a current to each of the motor coils according to the control by the energizing control section 30.

The current waveform generation section 20 changes a start timing of the de-energizing period according to a control signal CTL given by an external controller (not shown), etc. Specifically, the current waveform generation section 20 is configured of a segment dividing section 21, a de-energizing period specification section 22, and a waveform generation section 23. The segment dividing section 21 divides one cycle of BEMF into a plurality of segments, and outputs a segment signal θ indicating each segment. The de-energizing period specification section 22 is reset by BEMF, and outputs a de-energizing period signal TP which becomes a predetermined logic level during last ones of the plurality of segments corresponding to CTL. The waveform generation section 23 generates a current waveform based on TQ, θ, and TP.

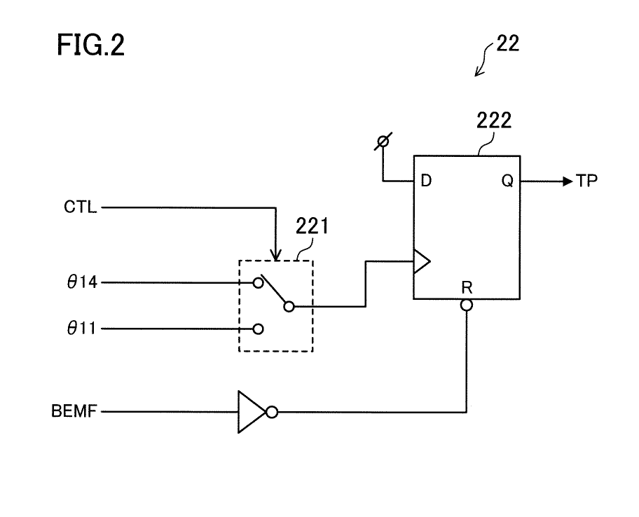

FIG. 2 illustrates an example configuration of the de-energizing period specification section 22. For convenience, one cycle of BEMF is divided into sixteen segments. A signal θ11 indicating the eleventh segment and a signal θ14 indicating the fourteenth segment are input to a selector 221. The selector 221 outputs θ11 when CTL is at the L level, and outputs θ14 when CTL is at the H level. A latch circuit 222 latches an H level signal in synchronization with the output of the selector 221, and is reset by BEMF. A Q output of the latch circuit 222 serves as TP.

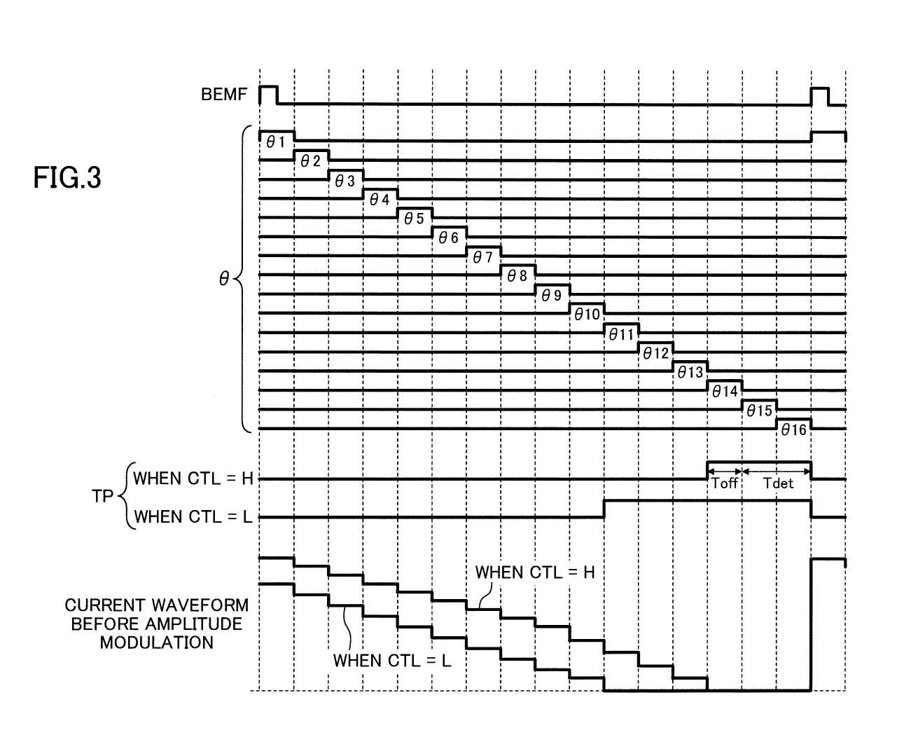

The operation of the current waveform generation section 20 will be described with reference to a waveform chart of FIG. 3. The segment dividing section 21 divides one cycle of BEMF into sixteen segments with one cycle delay, and outputs θ1-θ16 indicating respective segments. In this case, since the motor 100 is a three-phase motor, one cycle of the BEMF corresponds to an electrical angle of 60 degrees, and each of pulse widths of θ1-θ16 corresponds to an electrical angle of 3.75 degrees. When CTL is at the L level, the de-energizing period specification section 22 sets TP to be at the H level for a time from a rise of θ11 to a subsequent input of a pulse of BEMF. Thus, the waveform generation section 23 generates a current waveform in which a current is reduced in a stepwise manner during a period from θ1 to θ11 and is at the zero level during a period from θ11 to θ16. The de-energizing period in this case corresponds to an electrical angle of 22.5 degrees. This is a de-energizing period with a maximum width, which is set assuming the above-described worst case. Note that the current waveform shown in FIG. 3 is a waveform before amplitude modulation by TQ is performed, and a current waveform whose amplitude has been modulated according to TQ is input to the energizing control section 30.

When CTL is at the H level, the de-energizing period specification section 22 sets TP to be at the H level during a time from a rise of θ14 to a subsequent input of a pulse of BEMF. Thus, the waveform generation section 23 generates a current waveform in which a current is reduced in a stepwise manner during a period from θ1 to θ14 and is at the zero level during a period from θ14 to θ16. The de-energizing period in this case corresponds to an electrical angle of 11.25 degrees. This is a requisite minimum de-energizing period when the motor 100 is driven in a stable manner, for example, during constant rotation control, etc. Actually, a current waveform flowing through the motor 100 is slightly delayed from a current waveform generated by the current waveform generation section 20. Therefore, a period Toff corresponding to an electrical angle of 3.75 degrees is provided as a margin until a motor coil current reaches zero, so that a counter electromotive voltage is detected during a subsequent period Tdet corresponding to an electrical angle of 7.5 degrees.

As described above, according to this embodiment, the de-energizing period in sensorless motor driving can be caused to be variable. Thus, low-vibration/low-noise driving is allowed by reducing the de-energizing period when constant rotation control is performed, and stable driving in which false detection of a counter electromotive voltage does not occur is allowed by increasing the de-energizing period during acceleration control and deceleration control.

### Second Embodiment

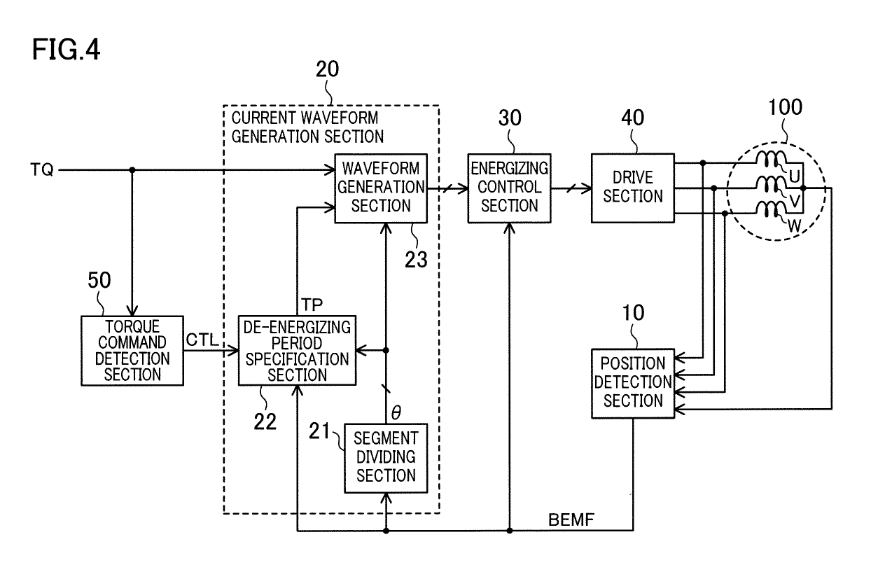

FIG. 4 illustrates a configuration of a motor drive unit according to a second embodiment. The motor drive unit of this embodiment is obtained by adding a torque command detection section 50 configured to generate CTL to the motor drive unit of the first embodiment.

The torque command detection section 50 detects an amount of change in TQ, and changes CTL according to a result of the detection. For example, when TQ is constant or is hardly changed, it is presumed that the motor 100 is under constant rotation control. Therefore, the torque command detection section 50 sets CTL to be at the H level. Thus, the de-energizing period is reduced, so that low-vibration/low-noise driving is allowed. When TQ is increased or reduced, it is presumed that the motor 100 is under acceleration control or deceleration control. Therefore, the torque command detection section 50 sets CTL to be at the L level. Thus, the de-energizing period is increased, so that stable driving in which false detection of a counter electromotive voltage does not occur is allowed.

### Third Embodiment

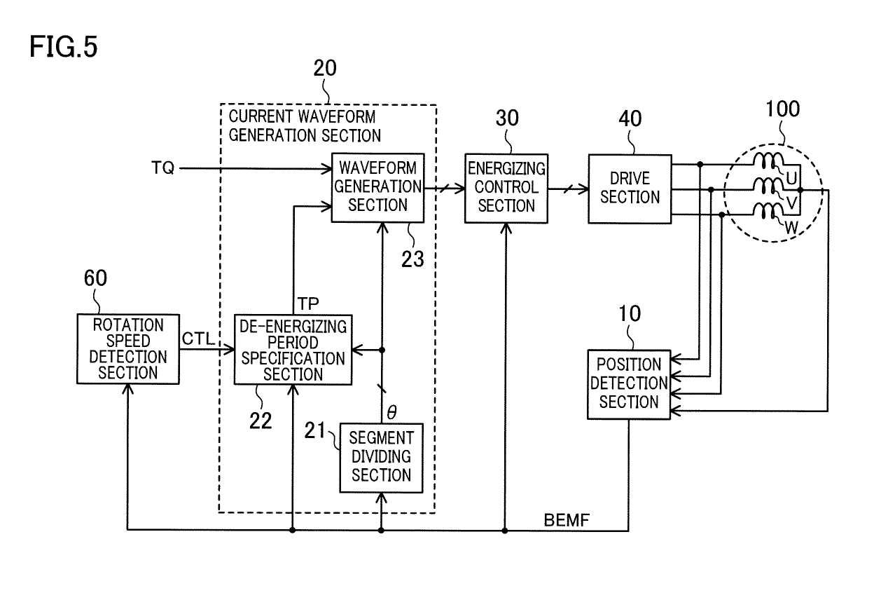

FIG. 5 illustrates a configuration of a motor drive unit according to a third embodiment. The motor drive unit of this embodiment is obtained by adding a rotation speed detection section 60 configured to generate CTL to the motor drive unit of the first embodiment.

The rotation speed detection section 60 detects an amount of change in rotation speed of the motor 100, and changes CTL according to a result of the detection. The rotation speed can be detected from an amount of change of the cycle of BEMF or any one of θ1-θ16. For convenience, the rotation speed is detected from BEMF. For example, when the cycle of BEMF is constant or is hardly changed, it is presumed that the motor 100 is under constant rotation control. Therefore, the rotation speed detection section 60 sets CTL to be at the H level. Thus, the de-energizing period is reduced, so that low-vibration/low-noise driving is allowed. When the cycle of BEMF is reduced or increased, it is presumed that the motor 100 is under acceleration control or deceleration control. Therefore, the rotation speed detection section 60 sets CTL to be at the L level. Thus, the de-energizing period is increased, so that stable driving in which false detection of a counter electromotive voltage is allowed.

### Fourth Embodiment

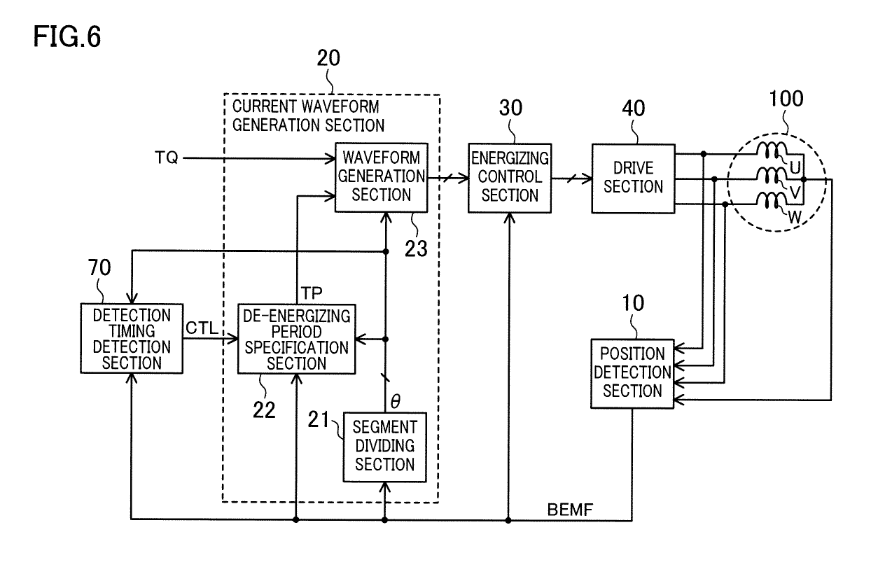

FIG. 6 illustrates a configuration of a motor drive unit according to a fourth embodiment. The motor drive unit of this embodiment is obtained by adding a detection timing detection section 70 configured to generate CTL to the motor drive unit of the first embodiment.

When the motor 100 rotates at constant speed, detection of a counter electromotive voltage is performed with a constant cycle. Thus, the detection timing of a counter electromotive voltage is synchronized with a certain timing (e.g., a timing corresponding to an electrical angle of 60 degrees) at all the time. However, when the detection timing is shifted from the certain timing, false detection might have occurred. Specifically, when the detection timing has occurred early in the period Tdet (FIG. 3), it is highly possible that false detection has occurred. If such a situation continues, the loss of synchronism occurs. Thus, the detection timing detection section 70 detects the detection timing of a counter electromotive voltage to change CTL according to a result of the detection.

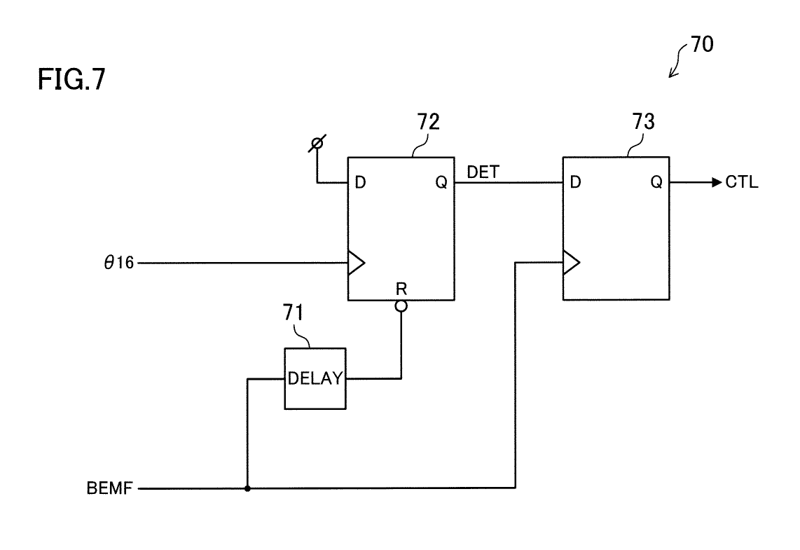

FIG. 7 illustrates an example configuration of the detection timing detection section 70. A delay circuit 71 outputs a signal which has been delayed from BEMF by an amount corresponding to the pulse width of BEMF. A latch circuit 72 latches the H level signal in synchronization with θ16 indicating the last one of the segments divided by the segment dividing section 21, and is reset by the output signal of the delay circuit 71. A latch circuit 73 latches a detection signal DET as a Q output of the latch circuit 72 in synchronization with BEMF. The Q output of the latch circuit 73 serves as CTL.

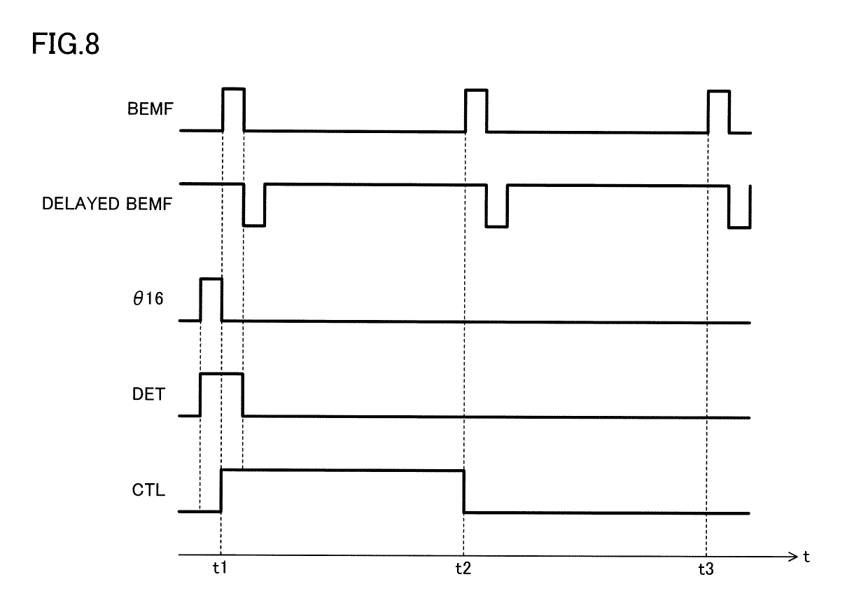

The operation of the detection timing detection section 70 will be described with reference to a waveform chart of FIG. 8. When the signal θ16 is input to the latch circuit 72, the latch circuit 72 latches the H level signal, and thus, DET becomes the H level. When the pulse of BEMF is input at a time t1, the latch circuit 73 latches DET at the H level, and thus, CTL becomes the H level. Thus, the de-energizing period is reduced, so that low-vibration/low-noise driving is allowed. Thereafter, the latch circuit 72 is reset by input of a pulse of delayed BEMF, so that DET becomes the L level, but CTL remains at the H level.

The pulse of BEMF is input at each of times t2 and t3. However, since θ16 is not input thereto immediately before the input of the pulse, DET remains at the L level. In other words, when a pulse of BEMF occurs before the generation of θ16, that is, when the timing of detection of a counter electromotive voltage is shifted from the certain timing, DET is maintained to be at the L level. Therefore, the latch circuit 73 latches DET at the timing of the input of the pulse of BEMF, so that CTL becomes the L level. Thus, the de-energizing period is increased, so that stable driving in which false detection of a counter electromotive voltage does not occur is allowed.

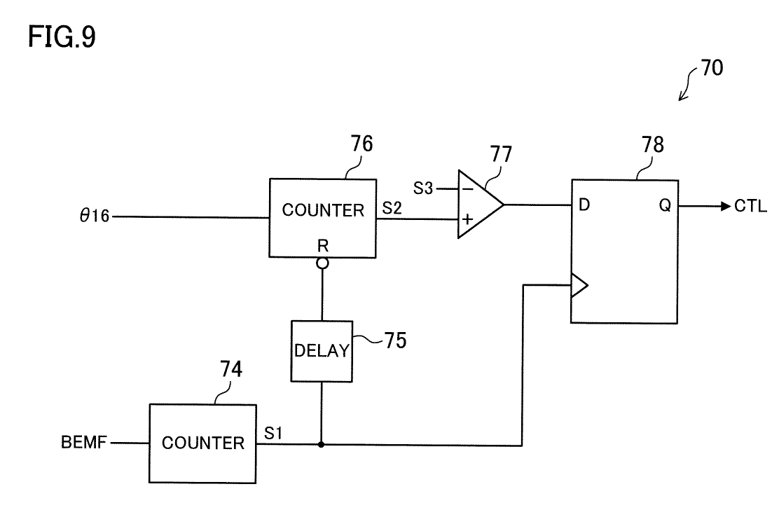

FIG. 9 illustrates another example configuration of the detection timing detection section 70. The counter circuit 74 counts a predetermined number of times of input of a pulse of BEMF, and then, outputs a pulse signal S1. A delay circuit 75 outputs a signal which has been delayed from S1 by an amount of the pulse width of the signal S1. A counter circuit 76 is reset by the output of the delay circuit 75, and counts input of a pulse of θ16 indicating the last one of the segments divided by the segment dividing section 21. A comparison circuit 77 compares a count value S2 of the counter circuit 76 to a predetermined value S3. For example, when S2≧S3, the comparison circuit 77 outputs the H level signal. A latch circuit 78 latches the output signal of the comparison circuit 77 in synchronization with S1. A Q output of the latch circuit 78 serves as CTL.

For example, assume that the number of counts by the counter circuit 74 is six and S3=5. If the correct detection timing has occurred in five times or more in the latest six counter electromotive voltage detections, CTL becomes the H level. Thus, the de-energizing period is reduced, so that low-vibration/low-noise driving is allowed. If the correct detection timing has occurred four times or less in the latest six counter electromotive voltage detections, in other words, when false detection has occurred twice or more in the latest six counter electromotive voltage detections, CTL becomes the L level. Thus, the de-energizing period is increased, so that stable driving in which false detection of a counter electromotive voltage does not occur is allowed.

### Fifth Embodiment

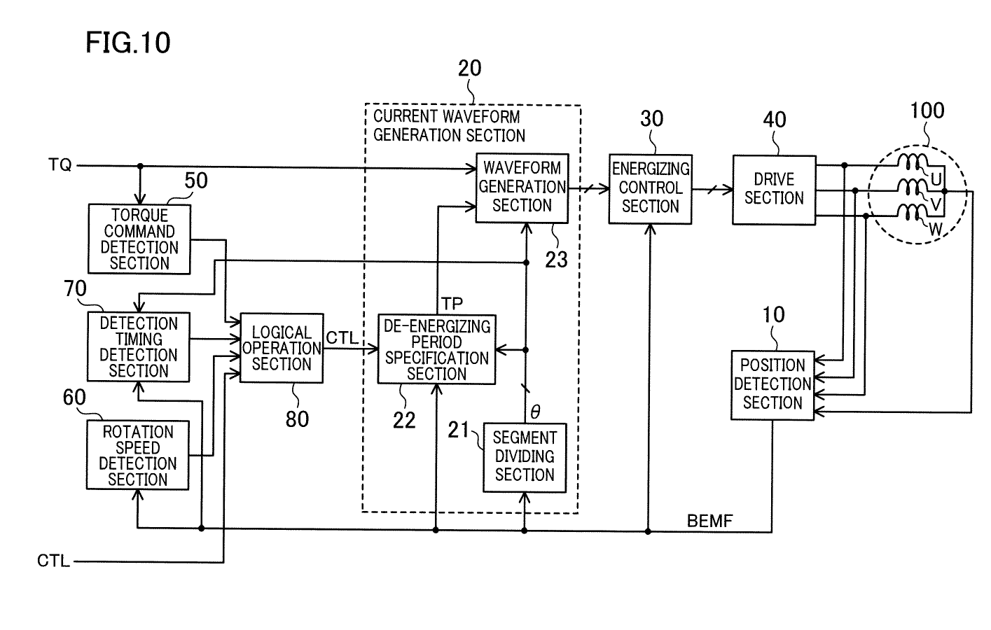

FIG. 10 illustrates a configuration of a motor drive unit according to a fifth embodiment. The motor drive unit of this embodiment includes all of the torque command detection section 50, the rotation speed detection section 60, and the detection timing detection section 70 which have been described above.

A logical operation section 80 performs a logical operation on an output signal of each of the above-described detection sections and an external signal CTL to generate a control signal CTL to be input to the current waveform generation section 20. The logical operation section 80 can be realized, for example, by a logic circuit configured to perform a logical OR on four input signals.

According to this embodiment, the de-energizing period can be adaptively changed according to results of detections of the torque command, the motor rotation speed, and the detection timing of the counter electromotive voltage, and also can be arbitrarily changed according to an external order. Note that each of the detection sections and the external signal CTL can be omitted as necessary.

In each of the above-described embodiments, the number of segments into which one cycle of BEMF is divided may be some other number than sixteen. If one cycle of BEMF is divided into more segments, a smoother current waveform can be generated. Also, the start timing of the de-energizing period may be synchronized with other signals than θ11 and θ14. Furthermore, the motor drive unit may be configured so that CTL is a signal having a large number of bits, and one of three or more timings may be selected as the start timing of the de-energizing period.

What is claimed is:

1. A drive unit which drives a sensorless motor, the drive unit comprising:
a position detection section configured to detect a rotor position of the motor by detecting a zero cross of a counter electromotive voltage generated on a motor coil during a de-energizing period to output a position detection signal;
a current waveform generation section configured to generate, based on a torque command signal and the position detection signal, a current waveform which is to flow through the motor, and which includes the de-energizing period;
an energizing control section configured to modulate the current waveform to generate a control signal for controlling energizing of each of the motor coils, and perform switching of an energizing phase of the motor based on the position detection signal; and
a drive section configured to supply a current to each of the motor coils according to the control by the energizing control section,
wherein the current waveform generation section changes a start timing of the de-energizing period according to a given control signal.

2. The motor drive unit of claim 1, wherein
the current waveform generation section includes
a segment dividing section configured to divide one cycle of the position detection signal into a plurality of segments to output a segment signal indicating an associated one of the segments,
a de-energizing period specification section configured to be reset by the position detection signal to output a de-energizing period signal which becomes a predetermined logic level during last ones of the plurality of segments corresponding to the control signal, and
a waveform generation section configured to generate the current waveform, based on the torque command signal, the segment signal, and the de-energizing period signal.

3. The motor drive unit of claim 1, further comprising:
a torque command detection section configured to generate a control signal,
wherein the torque command detection section detects an amount of change in the torque command signal, and changes the control signal according to a result of the detection.

4. The motor drive unit of claim 1, further comprising:
a rotation speed detection section configured to generate the control signal,
wherein the rotation speed detection section detects an amount of change in rotation speed of the motor, and changes the control signal according to a result of the detection.

5. The motor drive unit of claim 1, further comprising:
a detection timing detection section configured to generate the control signal,
wherein the detection timing detection section detects a detection timing of the counter electromotive voltage, and changes the control signal according to a result of the detection.

6. The motor drive unit of claim 5, wherein
the detection timing detection section includes
a delay circuit configured to output a signal which has been delayed from the position detection signal by an amount corresponding to a pulse width of the position detection signal,
a first latch circuit configured to be reset by the output signal of the delay circuit, and latch a signal at a predetermined logic level in synchronization with a signal indicating a last one of the segments, and
a second latch circuit configured to latch an output signal of the first latch circuit in synchronization with the position detection signal.

7. The motor drive unit of claim 5, wherein
the detection timing detection section includes
a first counter circuit configured to count a predetermined number of times of input of a pulse of the position detection signal to output a pulse signal,
a delay circuit configured to output a signal which has been delayed from the pulse signal by an amount corresponding to a pulse width of the pulse signal,
a second counter circuit configured to be reset by the output signal of the delay circuit, and count input of a pulse of a segment signal indicating a last one of the segments,
a comparison circuit configured to compare a count number of the second counter circuit to a predetermined value, and
a latch circuit configured to latch an output signal of the comparison circuit in synchronization with the pulse signal.

8. The motor drive unit of claim 1, further comprising:
a torque command detection section configured to detect an amount of change in the torque command signal to generate a first control signal according to a result of the detection,
a rotation speed detection section configured to detect an amount of change in a rotation speed of the motor to generate a second control signal according to a result of the detection,
a detection timing detection section configured to detect a detection timing of a counter electromotive voltage to generate a third control signal according to a result of the detection, and
a logical operation section configured to perform a logical operation on the first through third control signals and an external signal to generate the control signal.

9. The motor drive unit of claim 8, wherein
the detection timing detection section includes
a delay circuit configured to output a signal which has been delayed from the position detection signal by an amount corresponding to a pulse width of the position detection signal,
a first latch circuit configured to be reset by the output signal of the delay circuit, and latch a signal of a predetermined logic level in synchronization with a signal indicating a last one of the segments, and
a second latch circuit configured to latch an output signal of the first latch circuit in synchronization with the position detection signal.

10. The motor drive unit of claim 8, wherein
the detection timing detection section includes
a first counter circuit configured to count a predetermined number of times of input of a pulse of the position detection signal to output a pulse signal,
a delay circuit configured to output a signal which has been delayed from the pulse signal by an amount corresponding to a pulse width of the pulse signal,
a second counter circuit configured to be reset by the output signal of the delay circuit, and count input of a pulse of a segment signal indicating a last one of the segments,
a comparison circuit configured to compare a count value of the second counter circuit to a predetermined value, and
a latch circuit configured to latch an output signal of the comparison circuit in synchronization with the pulse signal.
